(19) United States
(12) Patent Application Publication
(10) Pub. No.: US 2013/0002826 A1
(43) Pub. Date: Jan. 3, 2013

(54) CALIBRATION DATA SELECTION DEVICE, METHOD OF SELECTION, SELECTION PROGRAM, AND THREE DIMENSIONAL POSITION MEASURING APPARATUS

(76) Inventors: Eiji Ishiyama, Saitama (JP); Tomonori Masuda, Saitama (JP)

(21) Appl. No.: 13/635,223

(22) PCT Filed: Apr. 1, 2011
(86) PCT No.: PCT/JP2011/058427

§ 371 Date: Sep. 14, 2012

(30) Foreign Application Priority Data
Apr. 6, 2010 (JP) 2010-087519

(51) Int. Cl. H04N 17/00; H04N 13/02

(52) U.S. Cl. 348/46; 348/187; 348/E17.002; 348/E13.002

(57) ABSTRACT

Appropriate selection of calibration data by shortening process time without wasteful processing is provided. Before measuring a three dimensional point of a target object from a stereo image, the calibration data according to an in-focus position of taking optical systems are applied to the stereo image. To select the calibration data, an object distance is acquired according to parallax obtained from the stereo image being reduced. The object distance is an estimated focusing distance corresponding to the in-focus position. One of the calibration data assigned with a set distance region in which the estimated focusing distance is included is selected. Respective view images are reduced in a range in which it is possible to detect any one of the set distance regions determined for a respective reference focusing distance corresponding to the calibration data.

### TECHNICAL FIELD

The present invention relates to a calibration data selection device, method of selection, selection program, and three dimensional position measuring apparatus for selecting calibration data for use with a parallax image at the time of measuring a three dimensional position.

### BACKGROUND ART

A stereo camera is known as a three dimensional position measuring apparatus for measuring three dimensional information of a target object. A pair of view images photographed by the cameras constitute the parallax image. According to parallax between corresponding points in the pair of the view images, a three dimensional position of the target object, namely coordinates (Xi, Yi, Zi) of a given point Pi on the target object in a three dimensional space, are obtained.

To measure the three dimensional position with high precision, it is necessary to eliminate distortion from the view images as a component derived from a characteristic of taking optical systems, such as aberration. Also, the view images must be corrected according to information on the basis of a correct focal length, position relation, direction and the like of the taking optical systems at the time of photography. Before analyzing the view images, calibration data created according to the characteristic of the taking optical systems are corrected in association with the view images. In the taking optical systems of which the focus is adjustable, it is necessary to select the calibration data according to a focus position at the time of photography and apply this to the view images, because the characteristic changes according to the focus position of the taking optical systems.

To select the calibration data according to the focus position in the above manner, it is necessary to designate the focus position at the time of photography. As a method of the designation, a method of designation from a step position of a stepping motor for moving a focus lens is known (Patent Document 1).

To obtain the parallax between the view images, correlation between pixels in the view images is checked according to correlation processing, to search the same photographing target points in the view images according to the correlation property, namely corresponding points. A calculating cost of the correlation processing is the higher according to highness in definition of the view images. The calculating cost considerably increases even with a slight increase in the definition. Thus, a fact that a range resolution becomes higher according to nearness in relation to a distance to the target object is considered. The view images are split into areas of plural distance regions. The areas are converted in such a manner that the definition is the lower according to the nearness of the distance of the areas. Such a device is known, in which the range resolution required for the entirety of the view images is obtained upon decreasing the calculating cost (See Patent Document 2).

### PRIOR ART DOCUMENTS

### Patent Documents

Patent Document 1: Japanese Patent Laid-open Publication No. 2008-241491
Patent Document 2: Japanese Patent Laid-open Publication No. 2001-126065

### SUMMARY OF INVENTION

### Problems to be Solved by the Invention

By the way, drive pulses for supply to the stepping motor are counted for designating the focus position from the step position of the stepping motor as disclosed in Patent Document 1. However, this is not preferable, because the focus position being correct cannot be detected if temporary stepping out occurs in the stepping motor or if shock has occurred to the taking optical systems to move the lens position irrespective of the drive pulses. Although the focus position being correct can be detected by use of an encoder for directly detecting a lens position, a problem arises in that providing such a mechanism cannot be adapted to a stereo camera suitable for many users because the number of parts or the cost will increase.

Also, another method may be conceived in which a focusing distance of focusing of the taking optical systems is specified by use of the parallax obtained from the view images without applying the calibration data to the view images or after applying suitable data of the calibration data to the view images. The focus position may be detected according to the focusing distance. However, the method is inefficient due to a wastefully long process time, because the processing is performed with a higher range resolution than required for the purpose of selecting the calibration data. The method of Patent Document 2, in which the definition is changed according to the distance region, is effective in decreasing the calculating cost. However, this can be used only for the view images of a specific distance distribution, and cannot be applied to the view images created in various kinds of scenes.

The present invention has been made in view of the foregoing problems, and has an object to provide a calibration data selection device, method of selection, selection program, and three dimensional position measuring apparatus, capable of selecting suitable data from the calibration data according to a parallax image without wasteful calculation.

### Means for Solving the Problems

In order to achieve the above object, a calibration data selection device according to the present invention includes an image acquisition unit for acquiring a plurality of view images photographed from different points by an imaging apparatus having a plurality of taking optical systems, a calibration data input unit for inputting calibration data corresponding to respectively plural reference focusing distances of the taking optical systems, an image reduction unit for reducing respectively the view images at a first reduction ratio in such a range that a definition of the view images is no less than a definition corresponding to a highest range resolution which is determined from the reference focusing distances corresponding to the calibration data and from set distance regions associated with respectively the reference focusing distances, the highest range resolution being required for determining in which of the set distance regions an object distance to a target object focused by the taking optical systems is included, a distance determining unit for acquiring a corresponding point between the view images reduced by the image reduction unit according to correlation processing, for determining the object distance to the target object focused by the taking optical systems according to parallax of the acquired corresponding point, and a calibration data selector for selecting calibration data from plural calibration data in such a manner that the object distance determined by the distance determining unit is within the set distance region.

Preferably, a focus area acquisition unit designates a focus area in the view images. The distance determining unit determines the object distance by use of the parallax of the corresponding point in the focus area designated by the focus area acquisition unit.

Preferably, the distance determining unit operates to acquire a corresponding point in the focus area designated by the focus area acquisition unit.

Preferably, also, a parallax detector detects parallax corresponding to a distance estimated for an in-focus state of the taking optical systems according to distribution of occurrence of the parallax of the corresponding point acquired by the distance determining unit for entirety of the view images. The distance determining unit acquires the object distance from the parallax detected by the parallax detector.

Preferably, also, the image reduction unit sets the first reduction ratio in a first direction of arrangement of the taking optical systems in the view images, and sets a second reduction ratio of the view images smaller than the first reduction ratio in a second direction perpendicular to the first direction.

Preferably, a correlation window correction unit adjusts an aspect ratio of a correlation window for use in the correlation processing of the distance determining unit according to the first and second reduction ratios.

Preferably, also, a focal length acquisition unit acquires a focal length of the taking optical systems having photographed a parallax image in the imaging apparatus set up in changing the focal length. The calibration data acquisition unit acquires calibration data for each of plural focal lengths of the taking optical systems according to the focal lengths. The image reduction unit sets the first reduction ratio from a reduction ratio in such a range that the definition of the view images is no less than the definition corresponding to the highest range resolution which is determined from the reference focusing distances corresponding to the calibration data for focal lengths acquired by the focal length acquisition unit and from a set distance region associated with the reference focusing distances. The calibration data selector selects calibration data corresponding to the object distance determined by the distance determining unit and the focal length acquired by the focal length acquisition unit.

Preferably, also, the image reduction unit includes a reduction ratio determining unit for acquiring imaging resolutions for measuring a distance from parallax between the view images being non-reduced for respectively the reference focusing distances according to basic information of the imaging apparatus inclusive of a base line length, a focal length and a pixel pitch in photography, for acquiring range resolutions for respectively the reference focusing distances according to a reference focusing distance corresponding to the calibration data and a set distance region associated therewith, and for determining the first reduction ratio from the imaging resolutions and the range resolutions.

Preferably, also, the reduction ratio determining unit carries out correction so that optical axes of the taking optical systems with a convergence angle are made parallel with one another in an approximation manner, to acquire the imaging resolutions.

Also, a three dimensional position measuring apparatus according to the present invention includes a calibration data selection device constructed as described above, an entry unit for applying the calibration data selected by the calibration data selection device to the view images being input for correcting the view images, and an arithmetic processing unit for determining three dimensional position information of the target object according to the parallax between the view images corrected by the entry unit.

Also, a calibration data selection method according to the present invention includes an image acquiring step of acquiring a plurality of view images photographed from different points by an imaging apparatus having a plurality of taking optical systems, a calibration data acquiring step of acquiring calibration data corresponding to respectively plural reference focusing distances of the taking optical systems, an image reduction step of reducing respectively the view images at a first reduction ratio in such a range that a definition of the view images is no less than a definition corresponding to a highest range resolution which is determined from the reference focusing distances corresponding to the calibration data and from set distance regions associated with respectively the reference focusing distances, the highest range resolution being required for determining in which of the set distance regions an object distance to a target object focused by the taking optical systems is included, a distance determining step of acquiring a corresponding point between the view images reduced by the image reduction step according to correlation processing, for determining the object distance to the target object focused by the taking optical systems according to parallax of the acquired corresponding point, and a calibration data selection step of selecting calibration data from plural calibration data in such a manner that the object distance determined by the determining step is within the set distance region.

Also, a calibration data selection program according to the present invention causes a computer to execute the image acquiring step, the calibration data acquiring step, the image reduction step, the distance determining step and the calibration data selection step as described above.

### Effect of the Invention

According to the present invention, respective view images are reduced in a range in which it is possible to detect any one of the set distance regions determined for a respective reference focusing distance corresponding to the calibration data. An object distance of a target object is acquired according to parallax obtained from the reduced view images, to select calibration data corresponding to the object distance. Consequently, it is possible to select appropriate calibration data by shortening process time without wasteful processing.

### BRIEF DESCRIPTION OF DRAWINGS

FIG. 1 is a block diagram showing a three dimensional position measuring apparatus;

FIG. 2 is an explanatory view showing one example of a calibration dataset corresponding to the plural focal lengths and a set distance region of each of the calibration data;

FIG. 3 is an explanatory view showing a measurement resolution;

FIG. 4 is a graph showing a relationship between the measurement resolution and an object distance on a far distance side, and a relationship with a reduction ratio;

FIG. 5 is a graph showing a relationship between the measurement resolution and an object distance on a near distance side, and a relationship with a reduction ratio;

FIG. 6 is a flow chart showing a process from selection of the calibration data to outputting 3D data;

FIG. 7 is a block diagram showing a construction of important elements of an example in which a face area of detected to designate a focus area;

FIG. 8 is a block diagram showing a construction of important elements of an example in which regions with a high frequency component of a larger amount are detected;

FIG. 9 is a block diagram showing a construction of important elements of an example in which parallax for determining an estimated focusing distance is designated from distribution of occurrence of the parallax;

FIG. 10 is a block diagram showing a three dimensional position measuring apparatus for acquiring camera information from calibration data;

FIG. 11 is an explanatory view showing a condition of creating the camera information from the calibration data;

FIG. 12 is a block diagram showing the three dimensional position measuring apparatus with correspondence to plural focal lengths;

FIG. 13 is a flow chart showing a process from selection of the calibration data at the time of correspondence to the plural focal lengths to outputting 3D data;

FIG. 14 is an explanatory view showing one example of a calibration dataset corresponding to the plural focal lengths and a set distance region of each of the calibration data;

FIG. 15 is a block diagram showing a construction of a three dimensional position measuring apparatus in which a reduction ratio in a vertical direction is determined discretely from a reduction ratio in a horizontal direction;

FIG. 16 is a block diagram showing a construction of important elements of an example in which a reduction ratio is determined by considering a convergence angle;

FIG. 17 is an explanatory view showing the convergence angle;

FIG. 18 is a block diagram showing a construction of important elements of an example in which correlation processing is carried out exclusively for a focus area;

FIG. 19 is a block diagram showing a construction of important elements of an example in which correlation processing is carried out exclusively for a focus area determined from a face area;

FIG. 20 is a block diagram showing correlation processing is carried out exclusively for a focus area determined with a high frequency component of a larger amount;

FIG. 21 is a block diagram showing a focusing distance estimating unit for estimating and outputting a focusing distance at the time of photographing a stereo image;

FIG. 22 is a flow chart showing a process at the time of estimating and outputting a focusing distance at the time of photographing a stereo image.

### MODE FOR CARRYING OUT THE INVENTION

### First Embodiment

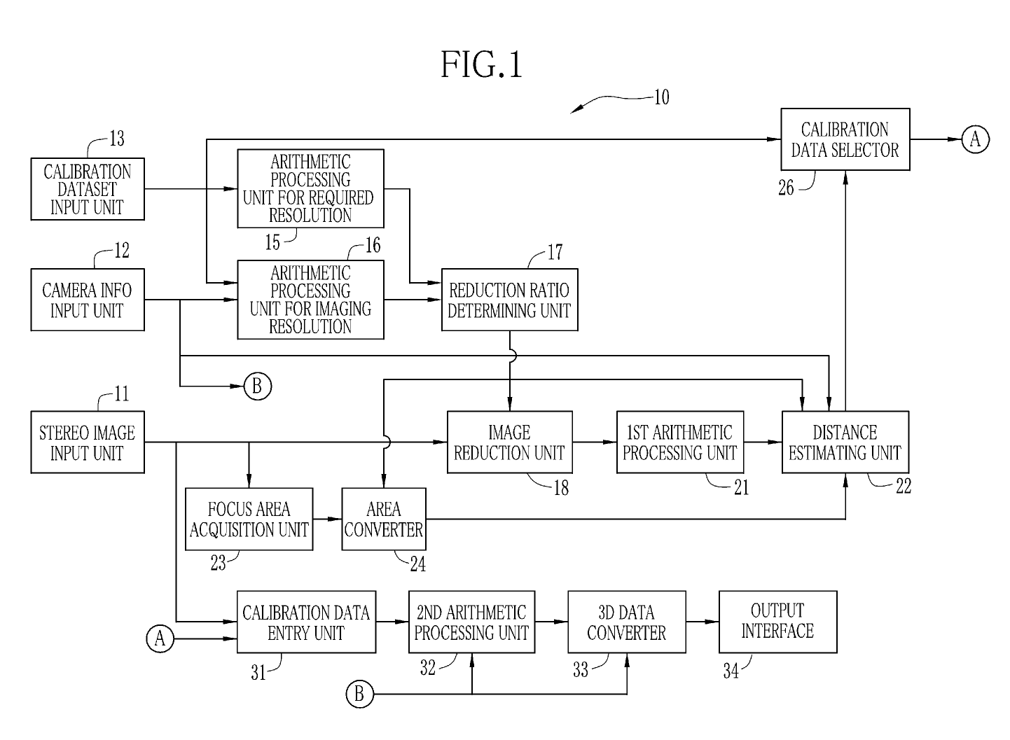

In FIG. 1, a three dimensional position measuring apparatus in which the present invention is embodied is shown. A three dimensional position measuring apparatus 10 measures three dimensional position information of a target object from a stereo image formed by photographing the target object with a stereo camera, or analyzes and retrieves coordinates (Xi, Yi, Zi) of a given point Pi on the target object in a three dimensional space. Before retrieving the position information, a task of processing is performed to estimate a distance of focusing (herein referred to as focusing distance) of taking optical systems at the time of photographing the target object. The stereo image is corrected according to calibration data for removing distortion of the taking optical systems according to the estimated focusing distance. The three dimensional position measuring apparatus 10 is constituted by, for example, a computer. Relevant elements are functioned by running a program in the computer for processing of estimating the focusing distance and measuring a three dimensional position.

A stereo image input unit 11 retrieves the stereo image created by the stereo camera for a target object. The stereo camera, as is well-known, includes the two taking optical systems on right and left sides, photographs the target object from the right and left view points through the taking optical systems, and outputs the stereo image as parallax image. The stereo image includes a left view image photographed from the left view point and a right view image photographed from the right view point. The stereo image input unit 11 is supplied with the stereo image assigned with tag information which is a focus area indicating an area in the stereo image focused by the stereo camera. Note that a direction of arrangement of the taking optical systems is not limited to the horizontal direction, but can be, for example, a vertical direction. Also, the image can be a parallax image including view images photographed from three or more view points.

A camera information input unit 12 obtains camera information (basic information) of the stereo camera having photographed a stereo image to be input. For the camera information, a base line length as an interval between the right and left taking optical systems, focal lengths and a pixel pitch are input. Note that precision of various values of the camera information may be low for determining an estimated focusing distance which will be described later.

A calibration dataset input unit 13 is supplied with a calibration dataset prepared initially. The calibration dataset to be input corresponds to the stereo camera having photographed the stereo image to be input. The calibration dataset includes plural calibration data for eliminating influence of distortion of the taking optical systems and their convergence angle.

The distortion and the like of the taking optical systems is different according to their focus position, namely lens position. Calibration data are previously prepared for plural focus positions as reference. A focusing distance (hereinafter referred to as reference focusing distance) as a reference corresponding to calibration data is associated with respectively the calibration data. Information of the focusing distance is input to the calibration dataset input unit 13 together with the calibration data. The reference focusing distance is a focusing distance of the taking optical systems as described above. The distance is determined according to the focus position as reference of the taking optical systems. The reference focusing distance is correlated to the focus position as reference.

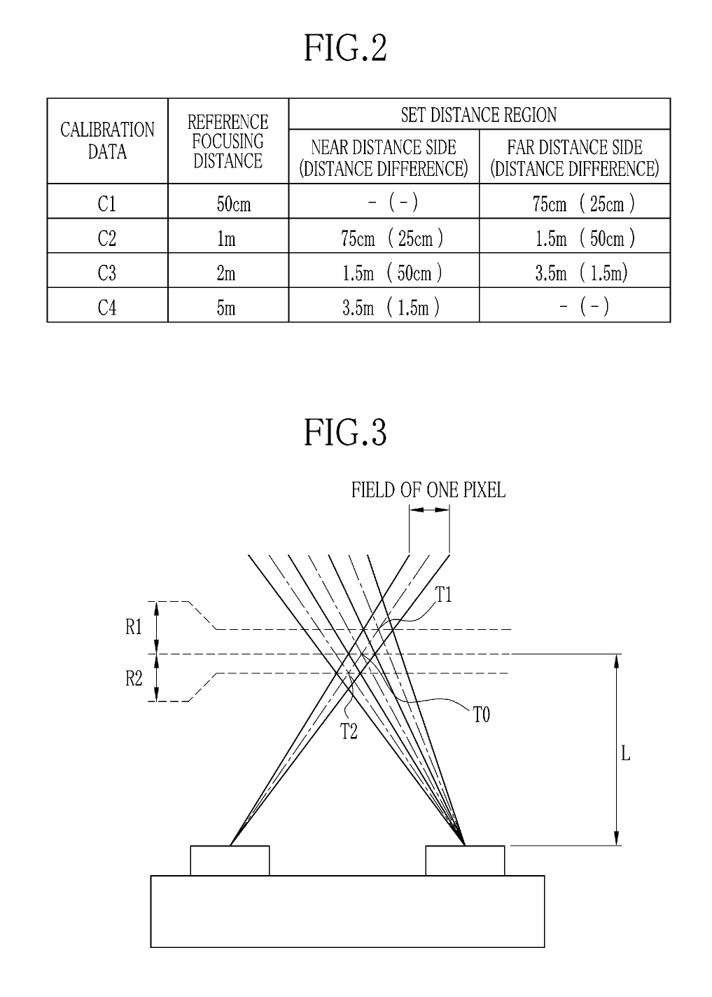

Creation of calibration data for the continuous focusing distance is not practical. As shown in FIG. 2, for example, calibration data are created in correspondence with several reference focusing distances set discretely. The calibration data are caused to correspond to distances other than the reference focusing distances in correspondence, and to a focusing distance within the set distance region determined for the reference focusing distance. In the embodiment, the three dimensional position measuring apparatus 10 determines the set distance region for the reference focusing distances. In the three dimensional position measuring apparatus 10, a median value between the reference focusing distances is used as a boundary value in the set distance region. The set distance region of one set of the calibration data is from the boundary value of the near distance side to a boundary value of the far distance side. One reference focusing distance is determined between the boundary values.

In an example of FIG. 2, calibration data C1-C4 are prepared in correspondence with four reference focusing distances (50 cm, 1 m, 2 m and 5 m). The three dimensional position measuring apparatus 10 has a set distance region from the close-up distance to the distance “75 cm” for the calibration data C1 according to the reference focusing distance “50 cm”. The boundary value of the distance “75 cm” is a median value of the respective reference focusing distances of the calibration data C1 and C2.

For the calibration data C2 corresponding to the reference focusing distance of “1 m”, the set distance region is from the distance of “75 cm” to the distance of “1.5 m”, wherein the distance of “75 cm” described above and a median value the of “1.5 m” between the calibration data C2 and C3 are boundary values. Similarly, for the calibration data C3, the set distance region is from the distance of “1.5 m” to the distance of “3.5 m”. For the calibration data C4, the set distance region is from the distance of “3.5 m” to the distance of the infinity.

A method of setting a set distance region is not limited to the above. For example, it is possible to predetermine a set distance region of the calibration data together with the calibration data, and input the set distance region to the three dimensional position measuring apparatus 10 with the calibration data. Also, the set distance region can be input manually.

An arithmetic processing unit 15 for required resolution constitutes an image reduction unit together with an arithmetic processing unit 16 for imaging resolution, a reduction ratio determining unit 17 and an image reduction unit 18. The arithmetic processing unit 15 retrieves reference focusing distances from the input calibration dataset, and determines a required resolution for each of the reference focusing distances. The required resolution is determined as range resolution required for finding in which of the set distance regions the object distance to the target object focused by the taking optical systems is included. The range resolution is a length (on the plane (to the right or left or up or down) and in the depth) in a three dimensional space corresponding to a pitch of one pixel. The required resolutions being determined are sent to the reduction ratio determining unit 17.

The arithmetic processing unit 16, when the three dimensional position is determined by use of the camera information and by use of all the pixels in the input view images, determines an imaging resolution as a measurement resolution (range resolution) in a depth direction. The imaging resolution differs according to the object distance to the target object even though the base line length, focal lengths, and pixel pitch on the image sensor are equal at the time of photography. The arithmetic processing unit 16 determines imaging resolutions in correspondence with respectively the reference focusing distances by using the reference focusing distance for the calibration data as the object distance. The imaging resolutions are sent to the reduction ratio determining unit 17.

The reduction ratio determining unit 17 operates according to the required resolutions from the arithmetic processing unit 15 and the imaging resolutions from the arithmetic processing unit 16, and determines a reduction ratio for reducing the definition of the view images in such a range that definitions of the view images are not lower than a definition according to the highest range resolution determined according to the reference focusing distances for the calibration data and their associated set distance regions. The reduction ratio is so determined that the range resolution at the time of obtaining the object distance of the target object by use of the reduced view images meets the highest required resolution among the required resolutions, and that highest possible effect of the reduction will be obtained. In the present embodiment, the reduction ratio of the highest possible effect of the reduction is obtained from the value K as an integer, where the reduction ratio is “1/K”.

The image reduction unit 18 reduces respective view images at the reduction ratio determined by the reduction ratio determining unit 17, to lower the definition of the view images. In the processing for the reduction, the view images are reduced so that a ratio of the pixel number after the reduction to the pixel number before the reduction is equal to the reduction ratio, in relation to the pixel numbers in the horizontal direction (direction of parallax) of view images and in the vertical direction perpendicular thereto. For example, let “1/K” be the reduction ratio. One pixel after the reduction is an average value of an area containing “KxK” pixels in the view image before the reduction. Also, it is possible to reduce the view images by processing of thinning according to the number based on the reduction ratio.

A first arithmetic processing unit 21 performs first arithmetic processing which includes the correlation processing and the parallax determination. In the correlation processing, view images after reduction by the image reduction unit 18 are processed for the correlation processing, to search corresponding points (pixels) in a right view image corresponding to reference points (pixels) in a left view image. In the parallax determination, parallax between the reference points detected by the correlation processing and their corresponding points is determined. A distance estimating unit 22 is supplied with a result of the first arithmetic processing. The parallax is obtained in a form of a shift amount (pixel number) between the reference points and their corresponding points.

A focus area acquisition unit 23 reads and analyzes tag information assigned to an input stereo image, and acquires a focus area. Coordinates of the focus area in the stereo image acquired by the focus area acquisition unit 23 before the reduction are converted by an area converter 24 into coordinates in a reduced stereo image according to the reduction ratio. The distance estimating unit 22 is supplied with the converted focus area.

The distance estimating unit 22 with the first arithmetic processing unit 21 constitutes a distance determining unit. The distance estimating unit 22 operates according to the parallax obtained from the focus area in a reduced view image, determines an object distance to a portion of the target object recorded in the focus area, and outputs this as an estimated focusing distance. For determining the estimated focusing distance, a pixel pitch, focal length, base line length, and reduction ratio of the view image are used together with the parallax from the first arithmetic processing unit 21.

A calibration data selector 26 selects calibration data associated with the estimated focusing distance from among calibration data respectively input as calibration datasets. For selecting the calibration data, the calibration data selector refers to the set distance region associated with the calibration data, so as to select calibration data in which the estimated focusing distance is within the set distance region. Thus, calibration data associated with the focus position of the taking optical systems at the time of photographing the stereo image is selected.

A calibration data entry unit 31 applies the calibration data selected by the calibration data selector 26 to view images without reduction, to eliminate influence of distortion of the taking optical systems and their convergence angle. A second arithmetic processing unit 32 performs second arithmetic processing including correlation processing and parallax determination. These of the second arithmetic processing are the same as those of the first arithmetic processing, but performed for the view images without reduction. A 3D data converter 33 is supplied with a result of the second arithmetic processing.

The 3D data converter 33 determines 3D data as three dimensional position information inclusive of a distance of a target object according to a pixel as a reference point in a left view image and a pixel as a point corresponding thereto in a right view image. An output interface 34 records the 3D data of the stereo image, for example, to a recording medium. The outputting method is not limited to this method, but can be a method of, for example, outputting to a monitor.

Determination of a reduction ratio is described now. An object distance L from the stereo camera to the measurement point is expressed in the following equation (1):

L=(D.f)/(B.d) (1)

where “D” is the base line length of the stereo camera for photography, “f” is the focal length, “B” is the pixel pitch, and “d” is the parallax.

A length corresponding to the parallax can be obtained by multiplying the parallax by the pixel pitch. If the view image is reduced, it is possible to obtain the length by use of a value determined by dividing the pixel pitch of the camera information by the reduction ratio. Therefore, a relationship of “P=B.d0=K.B.d1” is satisfied, where “P” is the length corresponding to the parallax, “B” is the pixel pitch of the camera information, “1/K” is the reduction ratio of the view images, “d0” is the parallax before the reduction, and “d1” is the parallax after the reduction.

As is well-known, the parallax is smaller if the measurement point is shifted in the far distance direction, and is larger if the measurement point is shifted in the near distance direction. In relation to a given object distance, let a measurement resolution be a change amount in the distance increasing or decreasing upon a change of the parallax of one pixel. As shown in FIG. 3, a difference between the object distance L and a distance of the measurement point T1 of the far distance side with the smaller parallax by one pixel is the measurement resolution R1 on the far distance side. A difference between the object distance L and a distance of the measurement point T2 of the near distance side with the larger parallax by one pixel is the measurement resolution R2 on the near distance side. Those can be expressed in the following equations (2) and (3). The measurement resolutions R1 and R2 can be expressed according to the following equations (2′) and (3′) based on the relation of the equation (1) by use of the base line length D of the stereo camera, focal length f, pixel pitch B and object distance L.

R1=[(D.f)/(B.(d−1))]−[(D.f)/(B.d)] (2)

=[L/(1−(B.L)/(D.f))]−L (2′)

R2=[(D.f)/(B.d)]−[(D.f)/(B.(d+1))] (3)

=L−[L/(1+(B.L)/(D.f))] (3′)

The imaging resolution can be determined as measurement resolutions of a far distance side and a near distance side obtained from the Equations (2′) and (3′) described above according to the base line length, focal length, pixel pitch, and object distance at the time of photography. The respective reference focusing distances are used as object distances, so it is possible to obtain the imaging resolution on the far distance side and the imaging resolution on the near distance side for each of the reference focusing distances.

On the other hand, for judging whether an object distance to be measured is within the set distance region of given calibration data, the measurement resolution of the far distance side obtained in the above manner with the reference focusing distance as the object distance needs to be Rf or lower, and the measurement resolution of the near distance side needs to be Rc or lower, where Rf is a difference between the reference focusing distance according to the calibration data and an upper limit of the set distance region, and Rc is a difference between the reference focusing distance according to the calibration data and a lower limit thereof. In relation to a given reference focusing distance, as a result, the difference between the reference focusing distance and the upper limit of the set distance region including the reference focusing distance is a required resolution on the far distance side. The difference between the reference focusing distance and the lower limit of the same is a required resolution on the near distance side. Thus, it is possible to obtain the required resolution on the far distance side and the near distance side for the respective reference focusing distances.

A reduction ratio is determined as a largest one of the values of a ratio of the imaging resolution to the required resolution (=imaging resolution/required resolution) in use of resolution of the same kind at an equal reference focusing distance. In short, a ratio of the imaging resolution on the far distance side to the required resolution on the far distance side is obtained for respectively the reference focusing distance. A ratio of the imaging resolution on the near distance side to the required resolution on the near distance side is obtained for respectively reference focusing distance. A highest one of the ratios is determined as the reduction ratio.

The measurement resolution is reduced further according to a decrease of the reduction ratio (=“1/K”). However, the reduced stereo image can meet the required resolution in correspondence with any one of the reference focusing distances by determining the reduction ratio in the above manner. The reduction ratio is determined by setting the value K as an integer for the reduction ratio equal to “1/K” in the above manner, for the purpose of simplifying the processing to reduce the image in which resolution of the stereo image can be minimized to raise efficiency in the correlation processing.

Note that the determined reduction ratio, for satisfying the required resolution for any one of the reference focusing distances, is one for maximum effect in the reduction according to the present example. However, it is unnecessary to maximize the effect in the reduction in determining a reduction ratio.

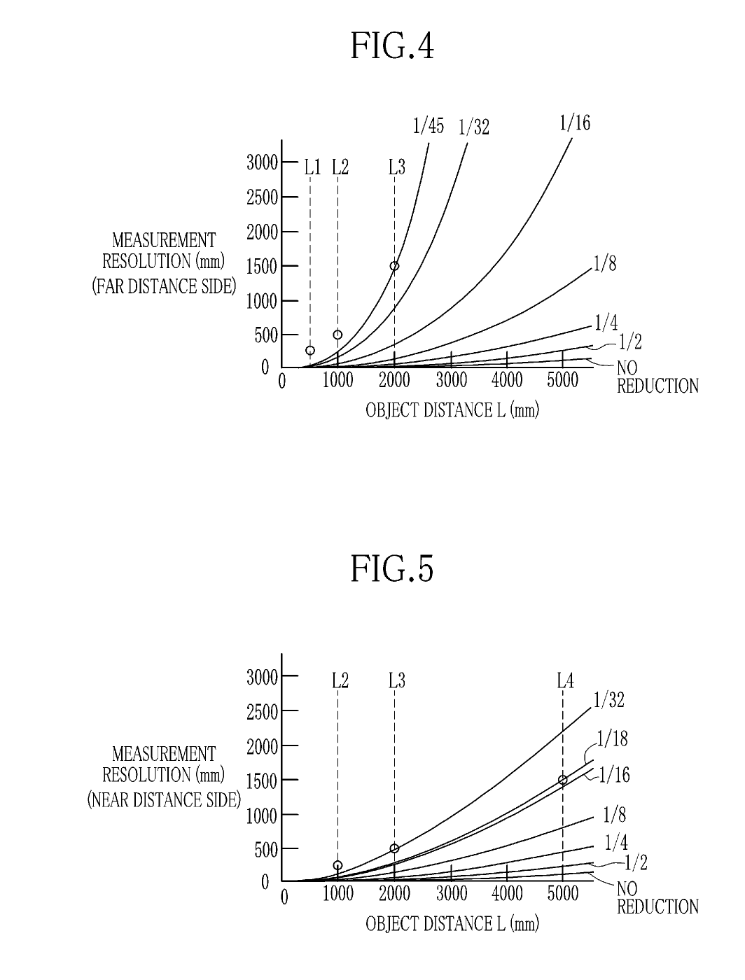

In FIGS. 4 and 5, one example of a relation between the object distance L from the stereo camera to the measurement point and a measurement resolution at the object distance L is shown. The measurement resolution is reduced according to an increase in the object distance L even without reducing view images. Influence of the reduction in the measurement resolution according to the reduction increases according to the increase in the object distance L. Furthermore, there is a tendency of reduction in the measurement resolution according to the decrease in the reduction ratio.

The reference focusing distances corresponding to the calibration data C1-C4 shown in FIG. 2 are designated by signs L1-L4. The required resolution is indicated by the signs “o” in FIGS. 4 and 5. In relation to the required resolution on the far distance side for the calibration data C1 and C2, if the reduction ratio is lower than “ 1/45”, the required resolutions “250 mm” and “500 mm” are satisfied at the reference focusing distance. However, for the calibration data C3, if the reduction ratio is lower than “ 1/45”, the required resolution “1,500 mm” is not satisfied at the reference focusing distance.

In relation to the required resolution on the near distance side for the calibration data C2 and C3, if the reduction ratio is lower than “ 1/32”, the required resolutions “250 mm” and “500 mm” are satisfied at the reference focusing distance. However, for the calibration data C4, if the reduction ratio is lower than “ 1/18”, the required resolution “1,500 mm” is not satisfied at the reference focusing distance. As a result, “ 1/18” is determined as a reduction ratio, because a ratio of the imaging resolution to the required resolution is the highest as reduction ratio.

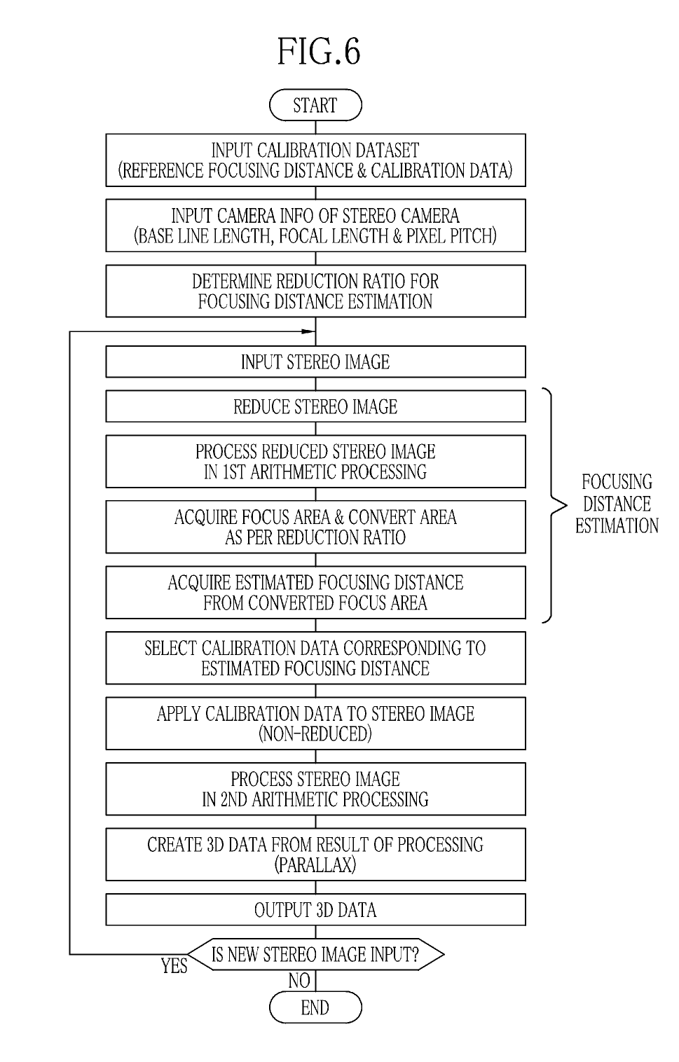

The operation of the above construction is described by referring to FIG. 6. At first, a calibration dataset is input by use of the calibration dataset input unit 13, being prepared for a stereo camera having photographed a stereo image for measuring a three dimensional position. Then the camera information of the stereo camera is input by use of the camera information input unit 12.

When the calibration dataset and the camera information are input, reference focusing distances are retrieved in correspondence with respective calibration data. According to the reference focusing distance, the arithmetic processing unit 15 obtains required resolutions for both of the far distance side and near distance side in correspondence with the reference focusing distances. Also, imaging resolutions for both of the far distance side and near distance side in correspondence with the reference focusing distances are obtained from the reference focusing distances and camera information.

A reduction ratio of the view image is determined by the reduction ratio determining unit 17 according to the respective required resolution and imaging resolution. At this time, the reduction ratio determining unit 17 obtains a ratio of the imaging resolution on the far distance side to the required resolution on the far distance side and a ratio of the imaging resolution on the near distance side to the required resolution on the near distance side, for each one of reference focusing distances. A highest one of the ratios is determined as reduction ratio.

When the stereo image input unit 11 inputs view images, those are sent to the image reduction unit 18 and the calibration data entry unit 31. The view images in the image reduction unit 18 are reduced at the reduction ratio determined by the reduction ratio determining unit 17. In the view images, the pixel number and the definition are decreased. The pixel pitch is increased so that the measurement resolution is reduced.

The view images reduced in the above manner are sent to the first arithmetic processing unit 21, and processed in the first arithmetic processing in their entire areas. Corresponding points are searched by correlation processing, to obtain parallax for reference points of the detected corresponding points. As the view images are reduced, correlation processing is completed in a shorter time than correlation processing for the input view images. Although the calibration data are not applied to the view images in the first arithmetic processing, it is possible without large failure to search the corresponding points, because of small influence of distortion in the taking optical systems or their convergence angle even without the calibration data as a result of reducing the view images. The position information of the obtained corresponding points and information of their parallax are sent to the distance estimating unit 22.

Also, the focus area, acquired by the focus area acquisition unit 23 analyzing the tag information assigned to the stereo image, is converted to coordinates in each reduced view image by the area converter 24, and sent to the distance estimating unit 22.

In the state of having input a result of the first arithmetic operation and the focus area converted in the above manner, the distance estimating unit 22 determines an object distance to a portion of the target object of the parallax, according to the camera information and the parallax of corresponding points detected in the converted focus area. The object distance is output as the estimated focusing distance.

When the estimated focusing distance is sent to the calibration data selector 26, calibration data of which the estimated focusing distance is included in the set distance region is selected from the various calibration data.

When the selected calibration data is sent to the calibration data entry unit 31, the calibration data is applied to the respective view image not reduced, so as to eliminate distortion of the taking optical systems in the stereo camera for photography. As described heretofore, the calibration data are selected according to the estimated focusing distance obtained from the respective reduced view images. Thus, the suitably selected calibration data are applied to the view images owing to the selection in the above manner.

The view images after application of the calibration data are processed in the second arithmetic processing by the second arithmetic processing unit 32. 3D data are determined according to a result of the second arithmetic processing by way of three dimensional position information including the distance of the target object for the pixels in the view images. The 3D data are recorded to a recording medium.

To measure three dimensional position information from stereo images successively photographed by the same stereo camera, common calibration data and camera information can be used. It is possible only to input the stereo images without inputting the data and information.

In the above embodiment, the focus area as a portion focused by the stereo camera is specified from the tag information assigned to the stereo image. However, the designation of the focus area is not limited to this method. For example, the focus area may be specified by analyzing the view images. A method according to analyzing the view images can be a method according to detecting a face area or an area containing a high frequency component of a larger amount.

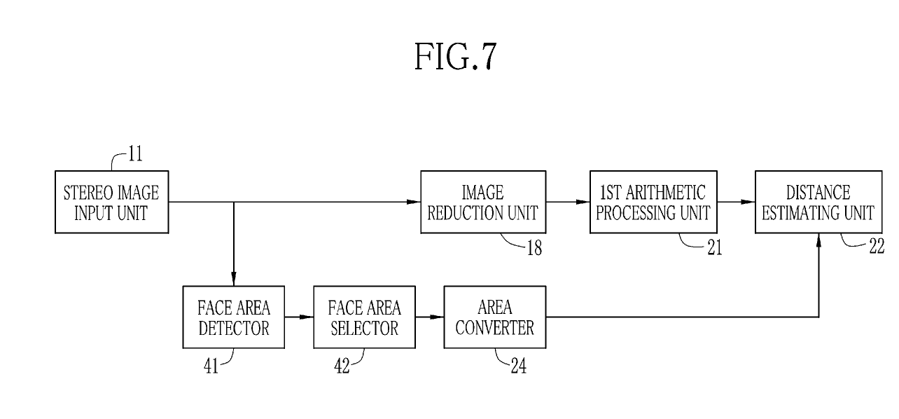

In an example of FIG. 7, a face area is used. A face area detector 41 detects respective face areas in view images. Any one of the detected face areas is selected by a face area selector 41 and specified as a focus area. This face area selected as focus area can be one near to the center of the view image among the face areas, a largest one of the face areas, or the like. This is useful in photographing a person, because a face of the person is focused very normally.

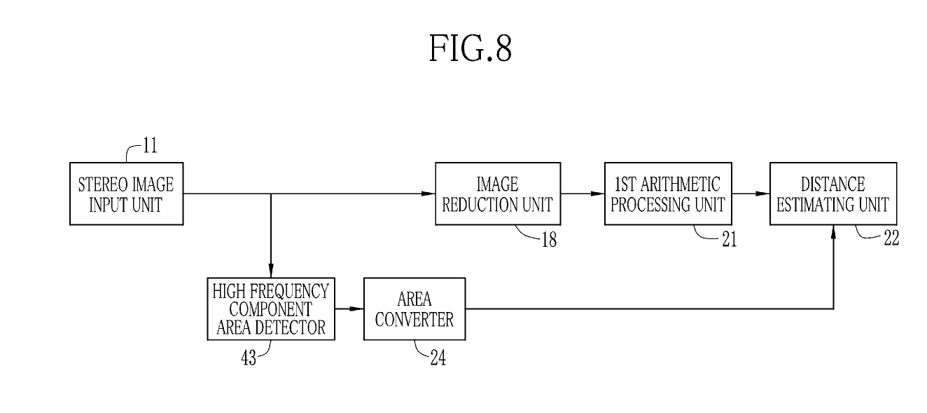

In an example of FIG. 8, a feature of increase of a high frequency component in a focused area is utilized. View images are split into several areas. A high frequency component area detector 43 checks content of the high frequency component in the respective split areas, and specifies one of the split areas as a focus area according to the highest amount of the high frequency component.

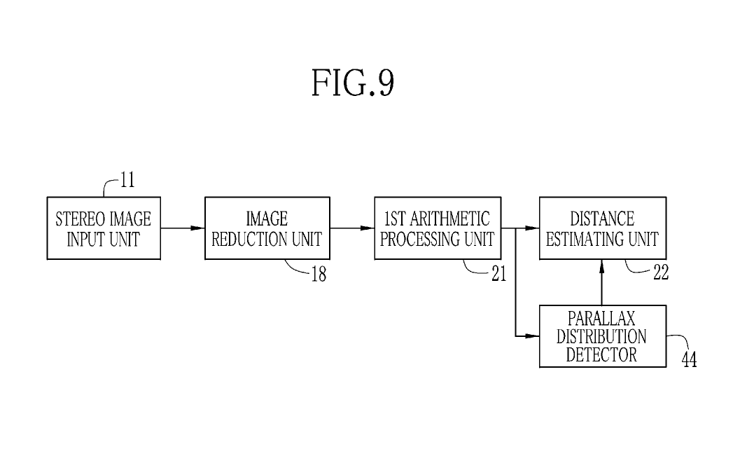

Instead of designation by way of the focus area, it is possible to designate parallax according to a distance of estimation of an in-focus state of the stereo camera. In an embodiment of FIG. 9, a parallax distribution detector 44 checks distribution of parallax of the entire area of view images obtained by the first arithmetic processing unit 21, and designates, for example, a mode value of parallax for the parallax according to a distance estimated for an in-focus state according to the distribution. It is possible to use a median value of parallax and the like instead of the mode value of parallax. Also, distribution of the distance can be checked instead of the parallax.

Note that only important portions are shown in FIGS. 7-9. Remaining portions are eliminated in the depiction.

### Second Embodiment

A second embodiment is described, in which camera information is acquired from calibration data. Portions of the embodiment other than those described hereinafter are the same as the first embodiment. Substantially the same elements are designated with the same reference numerals, to omit further description.

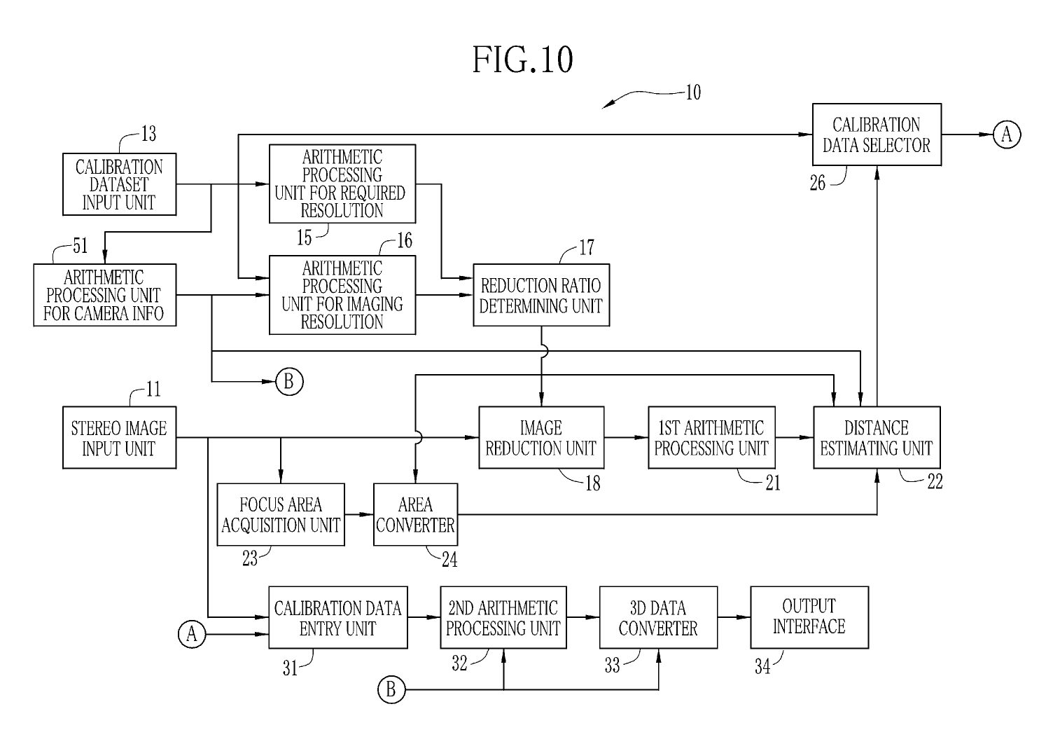

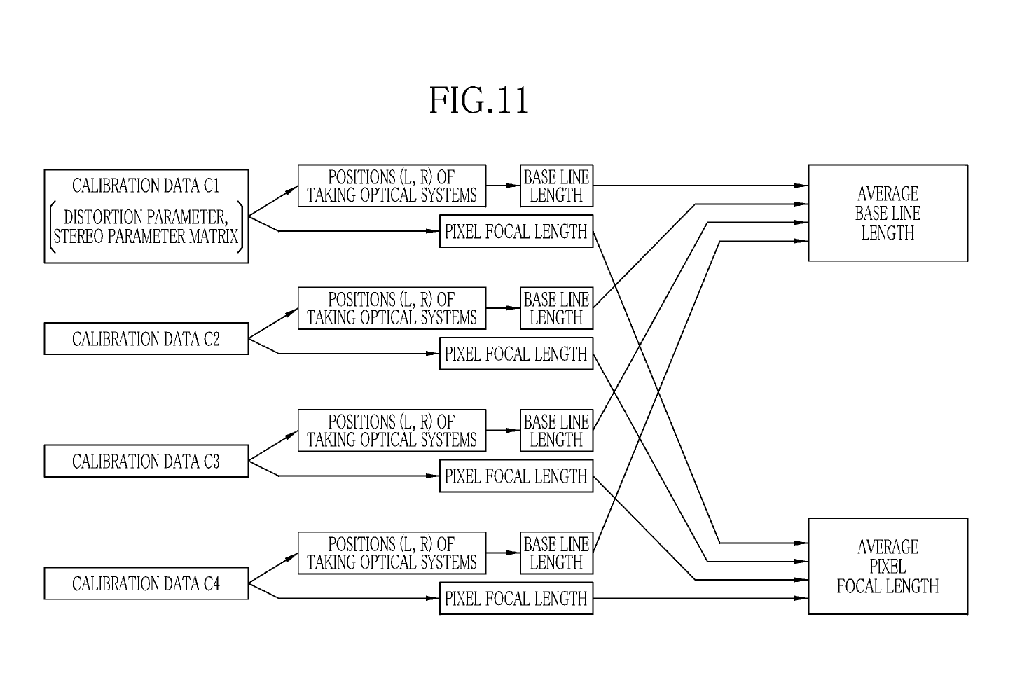

In the embodiment as shown in FIG. 10, an arithmetic processing unit 51 for camera information is provided as a camera information acquisition unit instead of the camera information input unit. Respective calibration data are input by the calibration dataset input unit 13 to the arithmetic processing unit 51. The arithmetic processing unit 51 analyzes the calibration data, and retrieves and outputs camera information.

As shown in FIG. 11, the calibration data is expressed by a stereo parameter matrix which correlates a distortion parameter for expressing distortion of the taking optical systems to coordinates in the three dimensional space, and the pixel position in the stereo image. The arithmetic processing unit 51 analyzes such calibration data and splits the calibration data into discrete parameters, to retrieve positions of the right and left taking optical systems (coordinates of the origin) and a pixel focal length. A base line length is determined from respective positions of the right and left taking optical systems. The pixel focal length is a dividend (focal length/pixel pitch) obtained by dividing the focal length of the taking optical systems by the pixel pitch. There is no problem even when there is no separation between the focal length and pixel pitch in the three dimensional position measurement.

The arithmetic processing unit 51 obtains the base line length and the pixel focal length from the respective calibration data, and outputs an average base line length and an average pixel focal length determined by averaging each of those as camera information. There are fine differences between the calibration data according to the focusing position of the taking optical systems. The camera information obtained from the calibration data is not correct in a precise meaning. However, no problem occurs in obtaining an estimated focusing distance from the view images with reduced measurement resolution for the purpose of selecting calibration data. Note that median values may be used instead of the average values. For example, the base line length and pixel focal length obtained from the selected calibration data can be used as basic information for use in the second arithmetic processing unit 32 and the 3D data converter 33.

### Third Embodiment

A third embodiment is described in correspondence with a stereo camera in which zoom lenses are used as taking optical systems. Portions of the embodiment other than those described hereinafter are the same as the first embodiment. Substantially the same elements are designated with the same reference numerals, to omit further description. In the third embodiment, a construction for photographing a stereo image is described in setting of the taking optical systems at one focal length of either of the wide-angle end and telephoto end. It is possible to apply the embodiment to other focal lengths, and to three or more focal lengths.

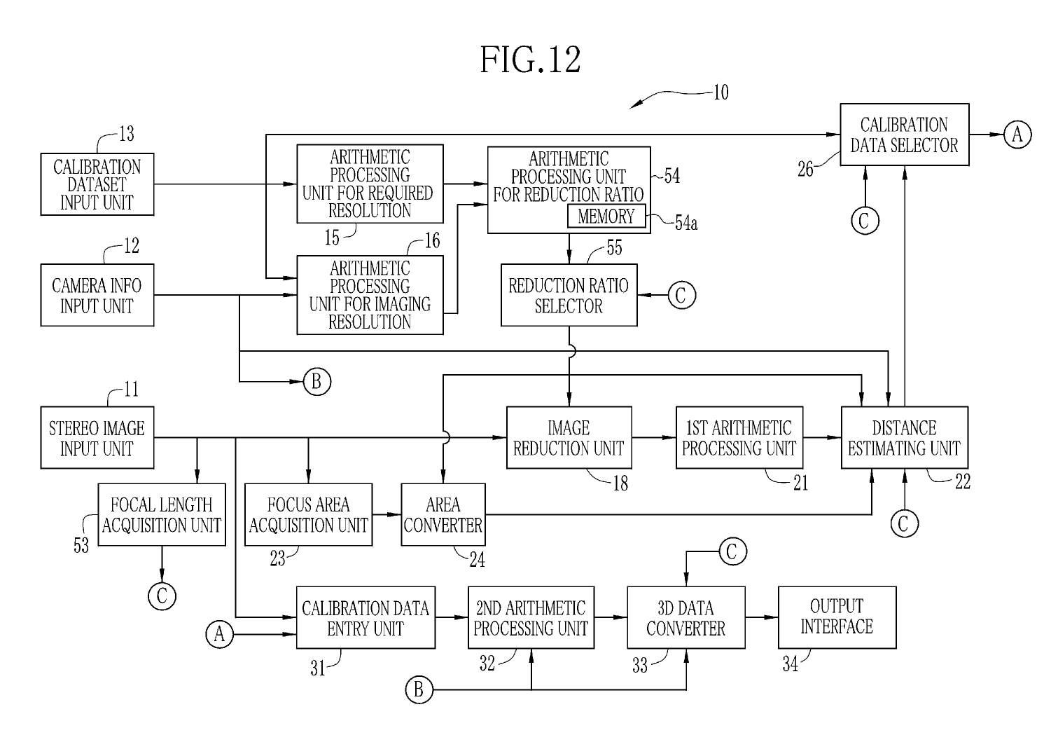

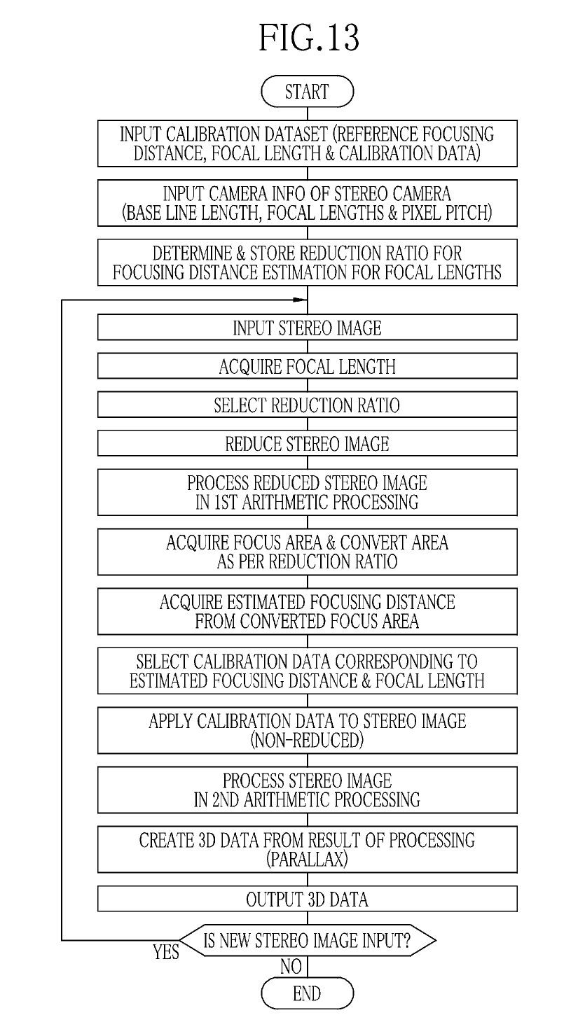

FIG. 12 shows a construction of the three dimensional position measuring apparatus 10 of the third embodiment. FIG. 13 shows steps of processing. The stereo image input unit 11 is supplied with a stereo image assigned with not only the focus area but a focal length of the taking optical systems used for photographing the stereo image as tag information. A focal length acquisition unit 53 acquires and outputs a particularly used focal length from the tag information of the stereo image being input. In the embodiment, the focal length acquisition unit 53 acquires a focal length of either of the telephoto end and the wide-angle end.

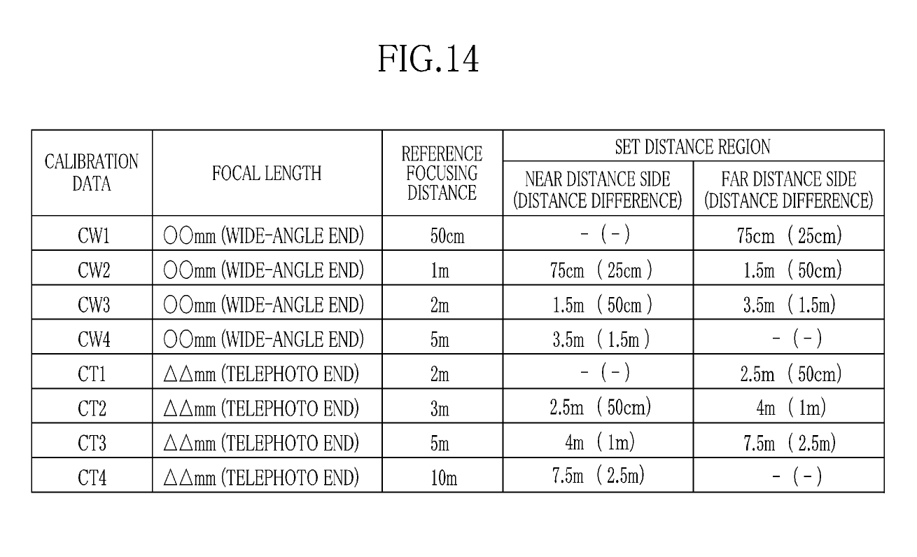

The camera information input unit 12 receives inputs of the base line length, pixel pitch, and focal lengths of the telephoto end and wide-angle end as camera information. In FIG. 14 showing one example, the calibration dataset input unit 13 receives an input of calibration datasets in which calibration data for each one of reference focusing distances are prepared for focal lengths.

The arithmetic processing unit 15 determines required resolutions for the far distance side and the near distance side for each of the focal lengths of the calibration data and for each of the reference focusing distances. The arithmetic processing unit 16 determines the imaging resolution of the far distance side and the near distance side for each of the focal lengths according to the camera information and for each of the reference focusing distances. An arithmetic processing unit 54 for a reduction ratio determines a reduction ratio according to the required resolutions and imaging resolution for each of the focal lengths in a manner similar to the reduction ratio determining unit 17 of the first embodiment. Thus, reduction ratios of the telephoto end and the wide-angle end are determined. The reduction ratios are written to a memory 54a.

A reduction ratio selector 55 is supplied with a focal length retrieved from the tag information of the stereo image. In response to the input of the focal length, the reduction ratio selector 55 retrieves a reduction ratio from the memory 54a in correspondence with the focal length, and sends the reduction ratio to the image reduction unit 18, the area converter 24 and the first arithmetic processing unit 21. Then the view images are reduced in such a manner as to satisfy the required resolution according to the focal length at which the input stereo image has been photographed, and to maximize the effect of the reduction. An estimated focusing distance is obtained from the view images.

The calibration data selector 26 selects calibration data corresponding to a focal length obtained from the tag information of the stereo image and the estimated focusing distance obtained by the distance estimating unit 22. The selected calibration data is applied to each of the view images.

### Fourth Embodiment

A fourth embodiment is described, in which vertical and horizontal reduction ratios of view images are determined discretely from one another. Portions of the embodiment other than those described hereinafter are the same as the first embodiment. Substantially the same elements are designated with the same reference numerals, to omit further description.

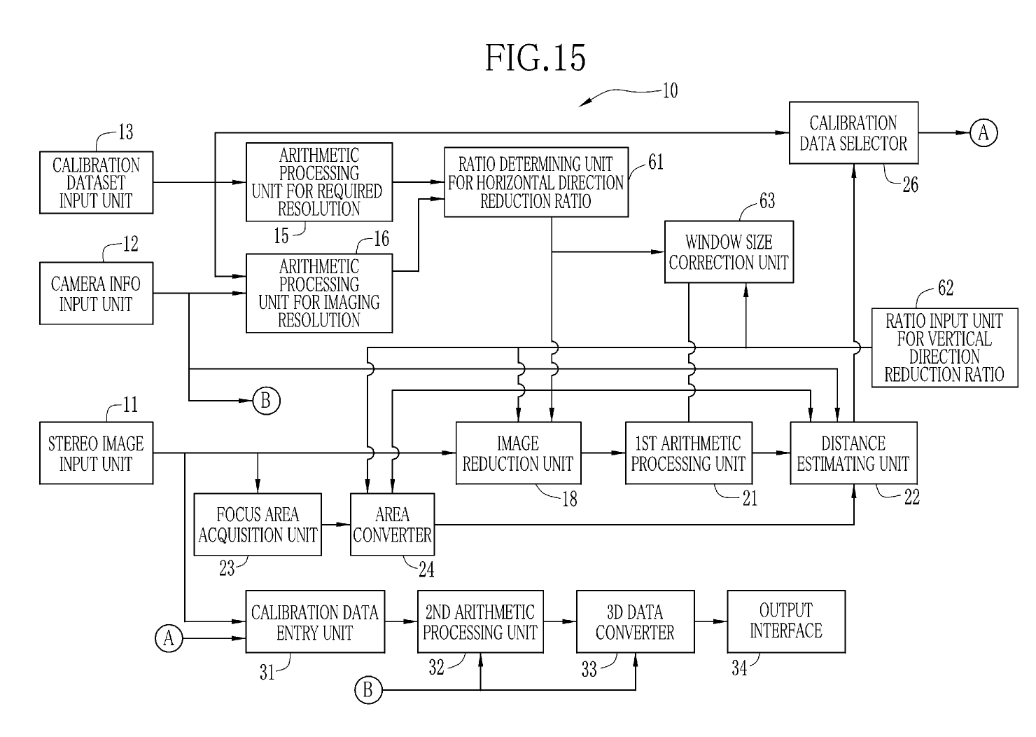

In FIG. 15, a ratio determining unit 61 for a horizontal direction reduction ratio is the same as the reduction ratio determining unit 17 but determines a reduction ratio which is output as horizontal direction reduction ratio (herein referred to as horizontal reduction ratio) of a view image. In the embodiment, the description is made by taking the horizontal direction in a direction of arrangement of the right and left taking optical systems on the view images, and taking the vertical direction in a direction perpendicular to the horizontal direction on the view images.

A ratio input unit 62 for a vertical direction reduction ratio is provided and operates for inputting a reduction ratio in the vertical direction (herein referred to as vertical direction reduction ratio). The respective view images are reduced by the image reduction unit 18 according to the horizontal reduction ratio from the ratio determining unit 61 in the horizontal reduction and according to the vertical reduction ratio from the ratio input unit 62 in the vertical reduction. Similarly for the focus area, the size of the focus area obtained by the area converter 24 is reduced according to the horizontal reduction ratio in the horizontal reduction, and according to the vertical reduction ratio in the vertical reduction, to adjust the aspect ratio.

A window size correction unit 63 corrects a size of a correlation window for use in the correlation processing according to the respective reduction ratios if the horizontal reduction ratio is different from the vertical reduction ratio. The correction is made to meet “Wv=Wh.Qv/Qh” where Wv is a vertical size of the correlation window, Wh is a horizontal size of the correlation window, Qv is the vertical reduction ratio, and Qh is the horizontal reduction ratio.

A difference in the distance in the depth direction is detected as a shift amount in a parallax direction of arranging the taking optical systems. The measurement resolution is influenced by reduction in the horizontal direction but not by reduction in the vertical direction. Therefore, a reduction ratio is determined for further reduction in the vertical direction than in the horizontal direction, so that a further decrease of processing time is possible without influencing the measurement resolution.

In the above embodiment, the absolute value of the vertical reduction ratio is input. However, a relative value of the vertical reduction ratio to the horizontal reduction ratio can be input. Also, it is possible automatically to set the vertical reduction ratio with further reduction than the horizontal reduction ratio instead of inputting the vertical reduction ratio.

### Fifth Embodiment

A fifth embodiment is described, in which an imaging resolution is determined in consideration of a convergence angle. Portions of the embodiment other than those described hereinafter are the same as the first embodiment. Substantially the same elements are designated with the same reference numerals, to omit further description.

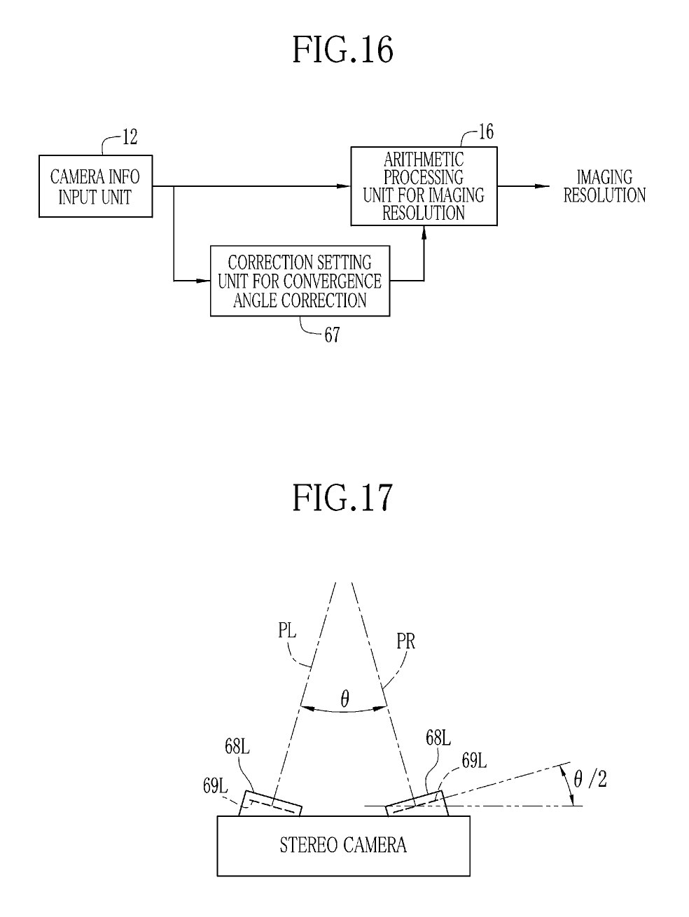

In the embodiment shown in FIG. 16, a correction setting unit 67 for convergence angle correction is provided. The correction setting unit 67 corrects arithmetic processing for determining the imaging resolution in the arithmetic processing unit 16 according to the convergence angle of the stereo camera as camera information input together with the base line length.

In this embodiment, the correction setting unit 67 corrects a pixel pitch for determining an imaging resolution if a convergence angle θ between taking optical systems 68L and 68R is given without parallelism between their optical axes PL and PR as shown in FIG. 17. Let “B0” be a pixel pitch of image sensors 69L and 69R before the correction. Let “B1” be a pixel pitch of those after the correction. The correction setting unit 67 performs the correction according to “B1=B0. cos(θ/2)”. Thus, the imaging resolution is determined by converting the pixel pitch B0 into an apparent pixel pitch B1 of the image sensors 69L and 69R as viewed from a front side of the stereo camera with an inclination of an angle (θ/2).

In the above description, the pixel pitch is corrected. However, a shift amount of a pixel can be corrected to determine the imaging resolution. If there is a convergence angle θ, the measurement distance is infinity (L=∞) on a condition of “d=(f/B). tan θ” where “d” is the shift amount of the pixel, “f” is a focal length of the taking optical systems and “B” is a pixel pitch. Also, if the axes of the taking optical systems are parallel without the convergence angle, “d=0” when the measurement distance is infinity. In short, the shift amount of a pixel is higher in case with the convergence angle θ than in case without the convergence angle. It is possible to treat without the convergence angle by correcting this amount. Accordingly, the imaging resolution can be determined by use of the shift amount d1 of the corrected pixel according to “d1=d0−(f/B). tan θ”, where “d0” is the shift amount of the pixel before the correction, and “d1” is the shift amount of the pixel after the correction.

Those above embodiments do not operate for strictly eliminating influence of the convergence angle, but can operate effectively enough to determine the imaging resolution for obtaining an estimated focusing distance. In a stereo camera of stereo photography for stereoscopy with human eyes, a convergence angle is assigned to the stereo camera normally for easy stereoscopy. The embodiments are effective in treating stereo images from such a stereo camera.

### Sixth Embodiment

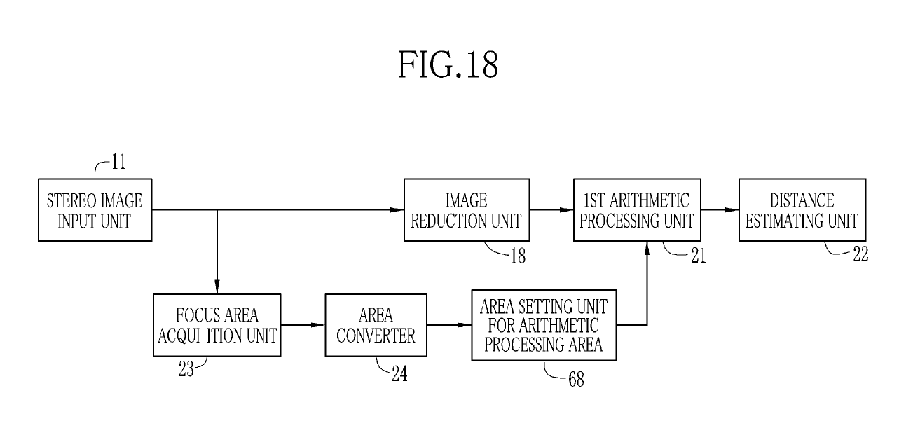

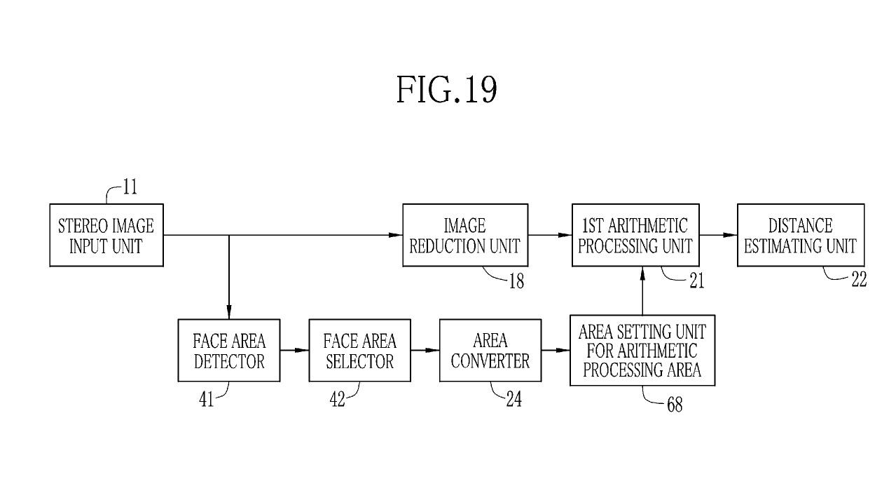

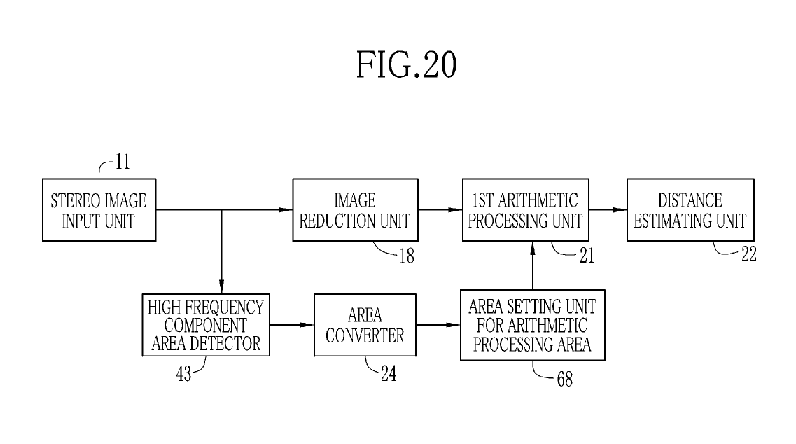

A sixth embodiment is described, in which an area is designated to perform correlation processing and determine parallax. Portions of the embodiment other than those described hereinafter are the same as the first embodiment. Substantially the same elements are designated with the same reference numerals, to omit further description. In FIG. 18, only important elements are shown, but remaining elements are omitted. In FIGS. 19 and 20, elements are shown similarly.

As shown in FIG. 18, an area setting unit 68 for an arithmetic processing area is provided. The area setting unit 68 causes the first arithmetic processing unit 21 to perform tasks of correlation processing and determining the parallax only for the focus area converted into an area in a view image reduced by the area converter 24. Thus, the processing time for searching corresponding points or obtaining parallax is shortened.

In the present embodiment, the area for the correlation processing and the parallax determination is limited to the focus area specified from the tag information. However, it is possible to utilize the embodiment in a manner of FIGS. 19 and 20 for designation of a face image detected or selected in a view image or a region with the highest amount of the high frequency component by way of a focus area.

### Seventh Embodiment

A seventh embodiment is described for an example of a focusing distance estimating unit for estimating and outputting a focusing distance upon photographing a stereo image. Portions of the embodiment other than those described hereinafter are the same as the first embodiment. Substantially the same elements are designated with the same reference numerals, to omit further description.

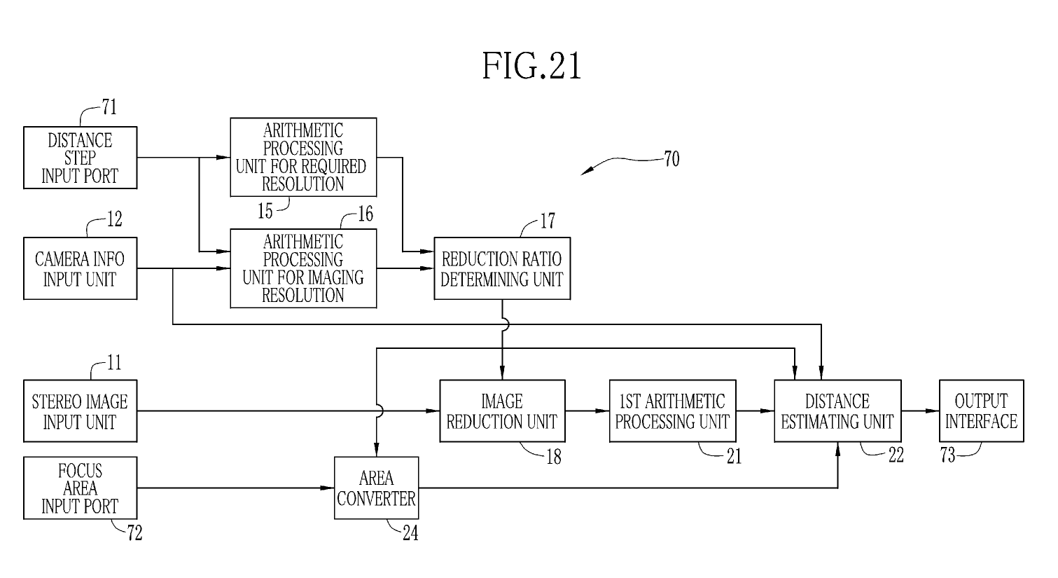

FIG. 21 shows the focusing distance estimating unit. A focusing distance estimating unit 70 estimates and outputs a focusing distance of taking optical systems of the stereo camera upon photographing a stereo image by inputting the stereo image photographed by the stereo camera or by inputting camera information of the stereo camera.

To a distance step input port 71, a reference focusing distance is input in correspondence to focus positions where the taking optical systems of the stereo camera can be set. For example, if the focus is adjusted by moving the taking optical systems of the stereo camera stepwise in focus positions corresponding to the object distances of 50 cm, 60 cm, 80 cm, 1 meter, 1.20 meters, 1.50 meters and the like, those object distances are input as reference focusing distances.

A focus area input port 72 is supplied with area information for focusing of the stereo camera. If the stereo camera is controlled to focus a center of an image frame, the area information input to the focus area input port 72 is coordinates of an area of the center in a view image.

An output interface 73 outputs an estimated focusing distance determined by the distance estimating unit 22, for example by recording this to a recording medium.

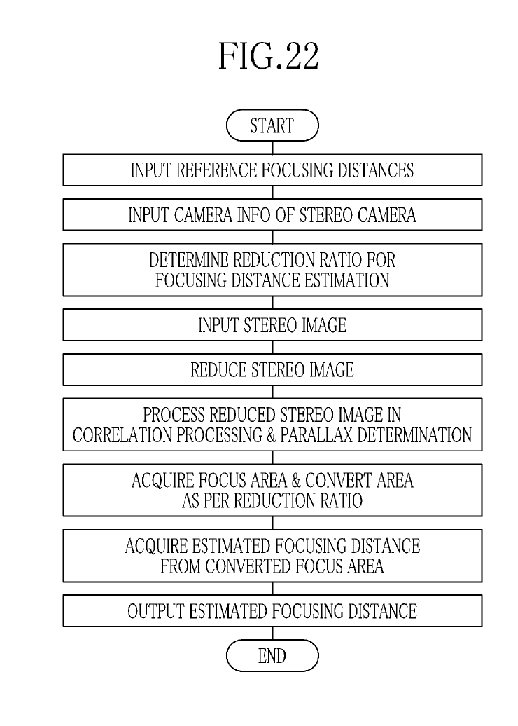

In the embodiment as shown in FIG. 22, a reduction ratio is determined upon inputting the respective reference focusing distance and the camera information of the stereo camera. The stereo image (each view image) being input is reduced at the reduction ratio. Then the correlation processing and the parallax determination are performed for the reduced stereo image to obtain values of the parallax. An object distance is determined by use of one of the values of the parallax corresponding to the inside of a focus area being input and converted according to the reduction, and is output as an estimated focusing distance.

The focusing distance estimating unit 70 described above can be used in connection with a stereo camera. For this structure, a memory is provided in the stereo camera for storing respective reference focusing distances, camera information and a focus area. It is possible to retrieve information from the memory, or to input stereo images directly from the memory. For photography by connection of the focusing distance estimating unit 70 with a stereo camera, it is possible to retrieve a focus area determined in the photography for events of changes of the focus area between shots. Also, it is possible to incorporate a function of the focusing distance estimating unit 70 in a stereo camera for detecting a focus position, instead of an encoder for detecting the focus position of the taking optical systems.

In the first to sixth embodiments described above, the three dimensional position measuring apparatus has been described as examples. However, a calibration data selection device can be constructed by use of functions including selection of calibration data. In the embodiments, a reduction ratio is determined in the apparatus. However, it is possible to create a reduction ratio with calibration datasets and input the reduction ratio together with the calibration datasets. Also, the structures of the embodiments described above can be combined together in a condition without inconsistency.

### DESCRIPTION OF THE REFERENCE NUMERALS

10 three dimensional position measuring apparatus
11 stereo image input unit
12 camera information input unit
13 calibration dataset input unit
17 reduction ratio determining unit
18 image reduction unit
21 first arithmetic processing unit
22 distance estimating unit
26 calibration data selector 1-12. (canceled)

13. A calibration data selection device comprising:
an image acquisition unit for acquiring a plurality of view images photographed from different points by an imaging apparatus having a plurality of taking optical systems;
a calibration data input unit for inputting calibration data corresponding to respectively plural reference focusing distances of said taking optical systems;
an image reduction unit for reducing respectively said view images at a first reduction ratio in such a range that a definition of said view images is no less than a definition corresponding to a highest range resolution which is determined from said reference focusing distances corresponding to said calibration data and from set distance regions associated with respectively said reference focusing distances, said highest range resolution being required for determining in which of said set distance regions an object distance to a target object focused by said taking optical systems is included;
a distance determining unit for acquiring a corresponding point between said view images reduced by said image reduction unit according to correlation processing, for determining said object distance to said target object focused by said taking optical systems according to parallax of said acquired corresponding point;
a calibration data selector for selecting calibration data from plural calibration data in such a manner that said object distance determined by said distance determining unit is within said set distance region.

14. A calibration data selection device as defined in claim 13, further comprising a focus area acquisition unit for designating a focus area in said view images;
wherein said distance determining unit determines said object distance by use of said parallax of said corresponding point in said focus area designated by said focus area acquisition unit.

15. A calibration data selection device as defined in claim 14, wherein said distance determining unit operates to acquire a corresponding point in said focus area designated by said focus area acquisition unit.

16. A calibration data selection device as defined in claim 13, further comprising a parallax detector for detecting parallax corresponding to a distance estimated for an in-focus state of said taking optical systems according to distribution of occurrence of said parallax of said corresponding point acquired by said distance determining unit for entirety of said view images;
wherein said distance determining unit acquires said object distance from said parallax detected by said parallax detector.

17. A calibration data selection device as defined in claim 13, wherein said image reduction unit sets said first reduction ratio in a first direction of arrangement of said taking optical systems in said view images, and sets a second reduction ratio of said view images smaller than said first reduction ratio in a second direction perpendicular to said first direction.

18. A calibration data selection device as defined in claim 17, further comprising a correlation window correction unit for adjusting an aspect ratio of a correlation window for use in said correlation processing of said distance determining unit according to said first and second reduction ratios.

19. A calibration data selection device as defined in claim 13, further comprising a focal length acquisition unit for acquiring a focal length of said taking optical systems having photographed said view images in said imaging apparatus set up in changing said focal length;
wherein said calibration data selector selects calibration data corresponding to said object distance determined by said distance determining unit and said focal length acquired by said focal length acquisition unit.

20. A calibration data selection device as defined in claim 13, further comprising a focal length acquisition unit for acquiring a focal length of said taking optical systems having photographed said view images in said imaging apparatus set up in changing said focal length;
wherein said calibration data input unit acquires calibration data for each of plural focal lengths of said taking optical systems according to said focal lengths;
said image reduction unit sets said first reduction ratio from a reduction ratio in such a range that said definition of said view images is no less than said definition corresponding to said highest range resolution which is determined from said reference focusing distances corresponding to said calibration data for focal lengths acquired by said focal length acquisition unit and from a set distance region associated with said reference focusing distances;
said calibration data selector selects calibration data corresponding to said object distance determined by said distance determining unit and said focal length acquired by said focal length acquisition unit.

21. A calibration data selection device as defined in claim 13, wherein said image reduction unit determines said first reduction ratio by use of basic information of said imaging apparatus inclusive of a base line length, a focal length and a pixel pitch in photography.

22. A calibration data selection device as defined in claim 13, wherein said image reduction unit includes a reduction ratio determining unit for acquiring imaging resolutions for measuring a distance from parallax between said view images being non-reduced for respectively said reference focusing distances according to basic information of said imaging apparatus inclusive of a base line length, a focal length and a pixel pitch in photography, for acquiring range resolutions for respectively said reference focusing distances according to a reference focusing distance corresponding to said calibration data and a set distance region associated therewith, and for determining said first reduction ratio from said imaging resolutions and said range resolutions.

23. A calibration data selection device as defined in claim 22, wherein said reduction ratio determining unit carries out correction so that optical axes of said taking optical systems with a convergence angle are made parallel with one another in an approximation manner, to acquire said imaging resolutions.

24. A three dimensional position measuring apparatus comprising:
a calibration data selection device as defined in claim 13;
an entry unit for applying said calibration data selected by said calibration data selection device to said view images being input for correcting said view images;
an arithmetic processing unit for determining three dimensional position information of said target object according to said parallax between said view images corrected by said entry unit.

25. A three dimensional position measuring apparatus as defined in claim 24, further comprising a focal length acquisition unit for acquiring a focal length of said taking optical systems having photographed said view images in said imaging apparatus set up in changing said focal length;
wherein said calibration data selector selects calibration data corresponding to said object distance determined by said distance determining unit and said focal length acquired by said focal length acquisition unit.

26. A three dimensional position measuring apparatus as defined in claim 24, wherein said image reduction unit determines said first reduction ratio by use of basic information of said imaging apparatus inclusive of a base line length, a focal length and a pixel pitch in photography.

27. A calibration data selection method comprising:
an image acquiring step of acquiring a plurality of view images photographed from different points by an imaging apparatus having a plurality of taking optical systems;
a calibration data acquiring step of acquiring calibration data corresponding to respectively plural reference focusing distances of said taking optical systems;
an image reduction step of reducing respectively said view images at a first reduction ratio in such a range that a definition of said view images is no less than a definition corresponding to a highest range resolution which is determined from said reference focusing distances corresponding to said calibration data and from set distance regions associated with respectively said reference focusing distances, said highest range resolution being required for determining in which of said set distance regions an object distance to a target object focused by said taking optical systems is included;
a distance determining step of acquiring a corresponding point between said view images reduced by said image reduction step according to correlation processing, for determining said object distance to said target object focused by said taking optical systems according to parallax of said acquired corresponding point;
a calibration data selection step of selecting calibration data from plural calibration data in such a manner that said object distance determined by said determining step is within said set distance region.

28. A calibration data selection method as defined in claim 27, further comprising a focal length acquisition step for acquiring a focal length of said taking optical systems having photographed said view images in said imaging apparatus set up in changing said focal length;
wherein, in said calibration data selection step, calibration data corresponding to said object distance determined by said distance determining step and said focal length acquired by said focal length acquisition step is selected.

29. A calibration data selection method as defined in claim 27, wherein in said image reduction step said first reduction ratio is determined by use of basic information of said imaging apparatus inclusive of a base line length, a focal length and a pixel pitch in photography.

30. A calibration data selection program causing a computer to execute said image acquiring step, said calibration data acquiring step, said image reduction step, said distance determining step and said calibration data selection step as defined in claim 27.

31. A calibration data selection program as defined in claim 30, causing said computer further to execute a focal length acquisition step for acquiring a focal length of said taking optical systems having photographed said view images in said imaging apparatus set up in changing said focal length;
wherein, in said calibration data selection step, calibration data corresponding to said object distance determined by said distance determining step and said focal length acquired by said focal length acquisition step is selected.

32. A calibration data selection program as defined in claim 30, wherein in said image reduction step said first reduction ratio is determined by use of basic information of said imaging apparatus inclusive of a base line length, a focal length and a pixel pitch in photography.
